(19) United States
(12) Patent Application Publication
(10) Pub. No.: US 2007/0102571 A1
(43) Pub. Date: May 10, 2007

(54) Airship for lifting heavy loads & methods of operation

(76) Inventor: Hokan S. Colting, Newmarket (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/253,753

(22) Filed: Oct. 20, 2005

(51) Int. Cl. B64B 1/02

(52) U.S. Cl. 244/30

(57) ABSTRACT

This invention relates to the field of buoyant aircraft and operation thereof, in particular, airships for lifting heavy and/or oversized loads. According to the present invention it would be advantageous to provide a airship that can lift heavy and/or oversized loads of several tons or more. The present invention is directed to an airship that will be able to load and unload heavy or oversized loads or payloads. The purpose of the airship of the present invention is to transport heavy and/or oversized payloads or act as a flying crane that requires a minimal infrastructure on the ground. The airship of the present invention uses the leverage of positive buoyancy to lift and transport payloads; using a fraction of the energy that a Vertical take off and landing aircraft (“VTOL”), such as a helicopter, would for the same payload weight. The airship of the present invention may also be able to lift far heavier loads than any existing helicopter.

### FIELD OF THE INVENTION

This invention relates to the field of buoyant aircraft and operation thereof, in particular, airships for lifting heavy and/or oversized loads.

### BACKGROUND OF THE INVENTION

The use of airships as a transporter of heavy (e.g. several tons or more) and/or oversized loads has long been contemplated. However, previous attempts at such airships have not been satisfactory. One of the most difficult challenges for using airships as transporters for heavy loads is the large fluctuations or variations in the weight, between loaded and unloaded and therefore the buoyancy, of such airships.

An airship is made buoyant by a lighter-than-air gas such as, for example, helium or hydrogen. Ideally, an airship should be generally neutrally buoyant (e.g. the weight of the airship is equal to the buoyancy of the lighter than air gas) and therefore floats in the air and only requires power to propel it through the air along with a method for regulating altitude. In reality, the buoyancy of the airship constantly varies due to factors such as changes in temperature and fuel load. To accommodate these changes in buoyancy, the airship, if it is an elongate generally ellipsoidal or cigar shape, can create aerodynamic lift either when flying through the air; in much the same way that lift is created from a wing on an airplane, or through vectored thrust from the airship's propellers. It will be understood that with a spherical airship, on the other hand, such as those, for example, set out in U.S. Pat. No. 5,294,076 as well as U.S. patent application Ser. Nos. 10/178,345 and 10/718,634, the content of which are incorporated herein by reference, can not create aerodynamic lift and therefore controls ascent and decent by vectored thrust from the airships engines/propellers. Despite the ability to compensate, there are limits both for how heavy airships can take-off and how light they can land. For example, some airships, such as those used in advertising, might take-off 200 kg heavy and, after several hours of flight, may have burned enough fuel so that they are 100 kg light upon landing. Greater fluctuations or variations in the weight or buoyancy of the airship cannot be overcome thought the use of the means noted above.

As noted above, there is a problem of aircraft buoyancy when attempting to lift heavy loads, in excess of several tons or more. While airships may have significant static lift (e.g. the positive or upward buoyant force of the lifting gas) and may be able to lift heavy loads, the problems occur when loading or unloading, as the addition or removal of large loads or payloads varies the airship's weight, and therefore its buoyancy. For example, where an airship is carrying a 10-ton payload, it will suddenly become 10 ton lighter when that load is removed or unloaded. Consequently, it has been necessary to provide mechanisms to compensate for the change in weight of the airship. For example, there has been suggested a load replacement system, such as, for example, the system provided in U.S. Pat. No. 6,231,007 to Schäfer, the contents of which are incorporated by reference, that replace the unloaded weight with water, sand or any other equal weight as ballast, simultaneously with the payload being unloaded. Such a load replacement system may be a significant disadvantage if loads are being taken to sites where there is no readily available supply of ballast material. Moreover, the time required to transfer ballast and to steady the airship while the transfer occurs adds to the complexity and costs of any such operation. As such, any system of this type may be awkward and impractical.

There are also difficulties associated with more traditional lifting aircraft, such as, for example, helicopters. While helicopters can lift relatively heavy loads, they are complicated, expensive and fuel inefficient. Further, as helicopters generally have a negative buoyancy (e.g. the force of gravity is greater than any buoyant or lifting forces), they also must lift their own weight. For example, the Russian built Mi-26 helicopter, considered the most powerful helicopter in the world, has an empty weight of 28 tons and can lift a load of 20 tons. As a result, this helicopter must have enough power to lift 48-tons, namely the total weight of the helicopter and payload. On the other hand, lighter-than-air aircraft, such as airships, are very efficient vertical lifters since they only require power for lifting the payload as the airship is assumed to already have neutral buoyancy. As such, airships are generally less costly to build and operate, for a given vertical lift capability, than heavier than air aircraft, such as helicopters.

Hybrid aircraft have also been proposed for heavy load lifting. A hybrid aircraft is an aircraft composed of elements taken from both lighter-than-air (“LTA”) (e.g. airships) and heavier-than-air (“HTA”) (e.g. helicopters) aircraft. In recent years there has been increasing interest in hybrid aircraft that combining elements of airships with propulsion elements from HTA aircraft, such as tilting propellers and rotors, to create aircraft aimed at obtaining the benefits of both types. A number of airship designs have been proposed that combine lighter than air buoyancy with traditional heavier than air components. One example of such an airship includes the airship described in U.S. Pat. No. 4,591,112 to Piasecki et al., the contents of which are hereby incorporated by reference, in which propulsive means are added to an lighter than air airship. The idea was for an airship to lift the helicopters, offsetting their empty weight, thereby freeing up all the potential lift from the helicopters for payload. Other examples include U.S. Pat. No. 4,052,025 to Clark et al.; U.S. Pat. No. 5,823,468 to Bothe; U.S. Pat. No. 4,695,012 and U.S. Pat. No. 4,601,444, both to Lindenbaum, the content of all of which are hereby incorporated by reference.

However, such hybrid airships have not met with success. In one example, the “Piasecki Heli-Stat”, the hybrid airship lost power and crashed. In another example, the “CargoLifter” did not succeed in making such an airship even after incurring significant costs.

It would be advantageous to provide a airship that can lift heavy and/or oversized loads of several tons or more.

### SUMMARY OF THE INVENTION

An aspect of the present invention is directed to a method of transporting a load from a loading site to a desired location with an airship comprising a reversible thrust apparatus, the method comprising: (a) operating the airship at the loading site, the airship having a net generally neutral buoyancy, the net generally neutral buoyancy arising from a positive buoyancy of the airship and a reverse lift from the thrust apparatus equal to the positive buoyancy of the airship; (b) loading the airship of step (a) with the load such that the airship has a negative buoyancy; (c) applying lift to the airship of step (b) from the thrust apparatus so as to maintain the net generally neutral buoyancy of the airship; (d) operating the loaded airship of step (c) to the desired location; and (e) unloading the airship of step (c) at the desired location.

Another aspect of the present invention is directed to A method of transporting a load from a loading site to a desired location with an airship comprising a reversible thrust apparatus, the method comprising: (a) operating the airship at the loading site, the airship having a net generally neutral buoyancy, the net generally neutral buoyancy arising from a positive buoyancy of the airship and a reverse lift generated by ballast; (b) loading the airship of step (a) with the load and unloading the ballast such that the airship has a negative buoyancy; (c) applying lift to the airship of step (b) from the thrust apparatus so as to maintain the net generally neutral buoyancy of the airship; (d) operating the loaded airship of step (c) to the desired location; and (e) unloading the airship of step (c) at the desired location.

### BRIEF DESCRIPTION OF THE DRAWINGS

Various objects, features and attendant advantages of the present invention will become more fully appreciated and better understood when considered in conjunction with the accompanying drawings, in which like reference characters designate the same or similar parts throughout the several views.

FIG. 1(a) and (b) are side and top views of an embodiment of the present invention;

FIG. 2 is a side view of a further embodiment of the present invention;

FIG. 3 is a top view of a further embodiment of the present invention

FIGS. 4 and 5 are side views of an embodiment of the present invention;

FIG. 6 is a side view of an embodiment of the present invention.

### DETAILED DESCRIPTION OF PREFERRED EMBODIMENTS

The description that follows, and the embodiments described therein, is provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

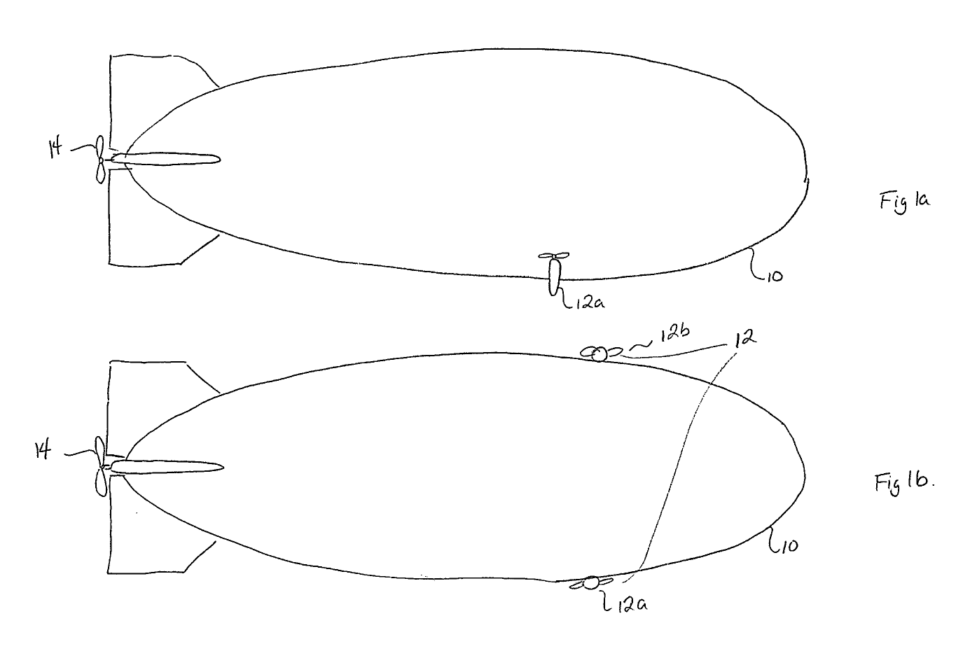

In order that the invention may be more fully understood, it will now be described, by way of example, with reference to the accompanying drawings in which FIGS. 1 through 6 illustrate embodiments of the present invention.

In the description and drawings herein, and unless noted otherwise, the terms “vertical”, “lateral” and “horizontal”, are references to a Cartesian co-ordinate system in which the vertical direction generally extends in an “up and down” orientation from bottom to top (z-axis) while the lateral direction generally extends in a “left to right” or “side to side” orientation (y-axis). In addition, the horizontal direction extends in a “front to back” orientation and can extend in an orientation that may extend out from or into the page (x-axis). Fore and aft (and leading and trailing) are terms having reference to the x-axis. The force of gravity and buoyancy, acts parallel to the z-axis.

As used in the specification, there are also defined three axes of rotation with respect to airships based on the center of gravity of the aircraft. Typically, the orientation of an aircraft can be defined by the amount of rotation of the parts of the aircraft along these three axes. Each axis of this coordinate system is perpendicular to the other two axes. For example, the pitch axis is perpendicular to the yaw axis and the roll axis. A pitch motion or “pitch”, also referred to as “trim”, is an up or down movement of the nose and tail of the aircraft along the z-axis. A yaw motion or “yaw” is a movement of the nose of the aircraft from side to side along the y-axis. In other words, if an aircraft model placed on a flat surface is spun or pivoted around its center of mass, it would be described as yawing. A roll motion or “roll” is a rotational movement of an airship along the x-axis. If the aircraft is thought of as having a vertical, or z-axis, a longitudinal, or x-axis, and a transverse, or y-axis, pitch is rotation about the y-axis, roll is rotation about the x-axis, and yawing is rotation about the z-axis. When described together, the orientation of an aircraft is typically referred to as “attitude”.

As noted above, the forces of gravity and buoyancy act parallel to the z-axis. As used in the specification, buoyancy refers to the forces acting on an object (e.g. an airship) suspended in a fluid (e.g. air) along or parallel to the z-axis. More specifically, it will be understood that the term “positive buoyancy” refers to an object tending to move upward along the z-axis, opposite to the force of gravity, while the term “negative buoyancy” refers to an object tending to move downward along the z-axis, along the force of gravity. It will be understood that the term “neutral buoyancy” refers to an object tending to not move along the z-axis in either a positive (e.g. upward) direction or a negative (e.g. downward) direction. The term “lift” refers to upward or buoyant forces acting on object such as an airship, against or opposite to the force of gravity.

There is a growing need for the vertical lifting of large payloads, particularly payloads comprising single integrated structures of relatively large dimensions, such as, for example, power plant assemblies, boilers, transformers, atomic power components, pre-fabricated structures, oil rigs, oil extraction equipment, windmills, etc. Typically, these large payloads are several tons, and in many cases are over 20 tons. Other important uses include hauling cargo between ship and shore, moving large structures such as bridge segments, and transporting houses and other buildings, manufactured in factories, to specific sites as well as supporting seismic testing and drilling site remediation. This is particularly true where lack of roads makes such operations very difficult or very expensive; for example, removing trees from forests to bring them to a logging site or to a sawmill or transporting equipment in remote areas for oil extraction.

The present invention is directed to an airship that will be able to load and unload heavy or oversized loads or payloads. The purpose of the airship of the present invention is to lift and transport heavy and/or oversized loads with minimal infrastructure on the ground. This airship will use the leverage of positive buoyancy to lift and transport payloads; using a fraction of the energy that a Vertical take off and landing aircraft (“VTOL”), such as a helicopter, would for the same payload weight. The airship of the present invention may also be able to lift far heavier loads than any existing helicopter.

Airships of the present invention can be elongated, spherical, and cylindrical or any other shape filled with a lifting gas such as helium or hydrogen. The airships of the present invention can be rigid or non-rigid. Unlike rigid airships which have an internal framework, non-rigid airships maintain their shape solely through pressure exerted on the interior surface of an envelope by the fluids (e.g. lifting gas and/or air) contained within an envelope. In that case, engines and rotors are mounted on frames attached to the surface of the airship by means apparent to those skilled in the art.

In an embodiment of the present invention is illustrated in FIGS. 1a and 1b. An airship 10 can be equipped with at least one pair of rotors 12. It will be understood that any combination of rotors suitable for the present invention will be encompassed herein, such as, for example, two or four pairs of rotors. Alternatively, one rotor capable of performing the necessary functions of the present invention may also be encompassed. In a preferred embodiment, there are one or two pairs of rotors. It will be understood that the term “rotor” generally refers to a rotor system comprising rotating airfoils, blades, wings or winglets, arranged to produce an upward or positive force (e.g. vertical thrust or lift) and engine(s) or power plant capable of generating the rotation of the airfoils or wings. As will be seen from FIGS. 1a and 1b, each of the rotors 12a and 12b is located on a side opposing the other member of the pair 12. As noted above, it will be understood that any position of rotors, including where the rotor is mounted in a vertical duct from the top to the bottom of the airships envelop would be encompassed by the present invention. Rotors 12a and 12b can be 2-blade or multi-blade helicopter-style rotors, generally of large diameter with low disc loading and able to produce high thrust from the power plants used. The rotors generally consist of a central hub which serves as a device to contain the blades. A plurality of blades, winglets, etc., are mounted in the hub with either fixed or adjustable pitch angles of the blades. The engines can be reciprocating gas or diesels, turbine, or any other type, driving the rotors directly or through belt, chain, gear or other type of reduction. The engine(s) could alternatively drive an electric generator(s) that in turn power electric motors that drives the rotors directly or through reduction drive(s).

As seen in FIG. 1b, rotor 12a is located on the left side of the airship with the airship facing forward, while rotor 12b is located on the right side of the airship. It will be understood, however, that this is merely one embodiment of the present invention. As noted above, any other combination of rotors that meet the requirements noted herein would also be encompassed by the present invention.

It will be understood that while the figures as shown only illustrate elongated or cigar shaped airships, airships of the present invention can be elongated, spherical, and cylindrical or any other shape. For ease of reference, only the elongated or cigar shaped airships are shown.

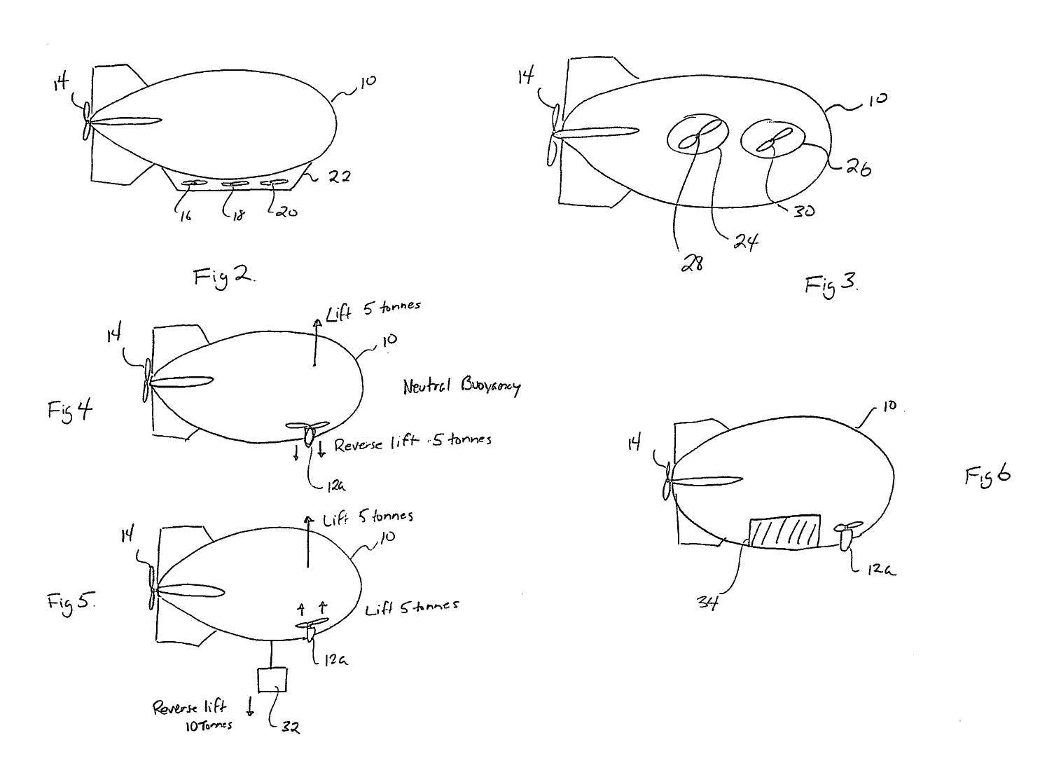

Other embodiments of the present invention provide that the rotors could also be mounted on a frame attached underneath the airship as illustrated in FIG. 2. As seen in FIG. 2, there is provided airship 10 having frame 22 with rotors 16, 18 and 20 provided attached thereto.

As seen in FIG. 1, there is also provided propulsion device 14, such as, for example, a propeller, for generating horizontal movement of airship 10. It will be understood that the term propeller when used herein refers to a form of rotor designed primarily to provide propulsion of the aircraft, as opposed to upward (e.g. lift) or downward forces; its rotational axis is normally parallel to the longitudinal or x-axis of the airship. It will be understood, however, that the propulsion of the airship could also be provided by additional rotors (not shown).

It will be understood that rotors 12a and 12b can have reversible pitch, which is well known by a person skilled in the art. Briefly, reversible pitch refers to changing the pitch of the rotor blades. In other words, the pitch of the rotor blades, winglets, etc., can be rotated below their positive angle or pitch, through flat pitch, until a desired negative blade pitch or angle is obtained. The pitch can be rotated, for example, by means of a pitch changing mechanism that may be operated hydraulically. When the blades rotate with a positive pitch, the rotors generate positive or upward vertical thrust or lift. When the blades of the rotors are rotated to have a negative pitch, the rotors generate negative or downward vertical thrust acting in the opposite direction to the lifting thrust produced when the blades have a positive pitch. It will be understood, therefore, that the reversible pitch rotors can produce either upward vertical thrust (e.g. lift) or downward vertical thrust (e.g. reverse lift).

As an alternative, the rotors can be powered by electric motors that are reversible, so as to adjust the direction of the rotation of the rotor blades, creating upward vertical thrust (e.g. lift) in one direction of rotation or (downward) negative lift in the other direction of rotation. Yet another configuration is with vertical ducts (generally cylindrical in shape and open in both ends) through the airship as illustrated in FIG. 3, and illustrates that a rotor can be mounted inside the vertical ducts. As seen in FIG. 3, there is provided a plurality of vertical ducts 24 and 26, extending through the airship 10. Provided within the vertical ducts 24 and 26 are rotors 28 and 30.

Alternatively, the rotors, with or without ducts, can be mounted with a frame onto the envelope. FIGS. 1 and 2 illustrate side views of rotors, without ducts, attached to a frame. The rotors, with or without ducts, can be mounted within a frame unto the envelop, as shown in FIG. 2. It will be understood that any combination of ducts and/or frames is contemplated within the present invention.

In one embodiment of the present invention, the airship would be operated as follows. Prior to loading the payload, the airship 10 is configured to have a “positive” buoyancy (e.g. the airship would tend to rise or float upwards if no downward force is applied thereto). As noted below, this positive buoyancy can be referred to as the “leveraged lift”. As used herein, the term “leveraged lift” refers to the amount of lift applied to a load or payload that is due to or arises from the positive buoyancy of the airship, when the load is attached to the airship, before lift from the rotors is applied. The degree to which the airship will be positively buoyant will depend on the nature of the payload. For example, with a preferred embodiment, the leveraged lift can be equal to 50% of the weight or downward force (e.g. reverse lift) of the payload. It will be understood that the leverage lift can be greater or less than 50% depending on the nature of the load. It will be further understood, therefore, that any amount or degree of positive buoyancy or leveraged lift could be encompassed by the present invention.

As a result of the positive buoyancy of the airship, there is lift (e.g. an upward vertical force) acting on the airship (see FIG. 4). In order to maintain a generally neutral buoyancy (e.g. the airship does not rise or sink) of the airship, rotors 12a and 12b (not shown) apply reverse lift (e.g. downward vertical thrust) equal to the upward force acting on the airship due to its positive buoyancy (see FIG. 4). As a result of the reverse lift applied to the airships by rotors 12a and 12b, airship 10 will be generally neutrally buoyant.

It should be noted that the buoyancy of an airship constantly varies due to factors such as changes in temperature and fuel load. For example, today's traditional advertising airships might take-off 200 kg heavy and, after several hours of flight, may have burned enough fuel so that they are 100 kg light upon landing. In the regular course of operating an airship that is “light” (e.g. the airship has a positive buoyancy as the upward acting lifting force of the lifting gases is greater than the downward acting force due to the weight of the airship), some kind of downward directed force has to be employed in order to hold position at a specific altitude or to descend. This downward acting force that can be from vectored thrust or from swivelling rotors, are merely control forces. These control forces cannot, however, be used to lift heavy or oversized objects such as those noted herein, thus distinguishing these controlling manoeuvres or controlling forces from the leveraged lift of the present invention. Great variations in the weight of an airship, due to large or oversized loads, cannot be overcome thought the use of the means noted above. As a result, the small control forces applied to airships to compensate for minor differences in buoyancy are different that the leveraged lift due to the positive buoyancy to lift heavy or oversized loads, as described here

After loading airship 10 with a payload having a weight (e.g. downward acting force) greater than the lift acting on the airship due to its positive buoyancy, the airship will then have a net “negative” buoyancy (e.g. the airship would tend to fall or sink downwards) if no force acted upon it (see FIG. 5). This net negative buoyancy will result from the net downward force (e.g. weight) of the payload. The net downward or negative force acting on the airship will be the difference between the upward force (e.g. lift) of the positively buoyant airship and the weight or downward acting force of the payload.

In order to maintain the net neutral buoyancy of the airship 10, the rotors 12a and 12b can be used to generate lift equal to the net downward or negative force of the airship (see FIG. 5). For example, the pitch of the rotors could be reversed or the direction of rotation of the rotors could be changes so as to apply an upward force to the airship equal to that of the net downward or negative force of the now negatively buoyant airship. As a result of the upward vertical thrust of the rotors applied to the airship, the airship will have a net neutral buoyancy. Once loaded, the airship can then transport the load to the desired location.

It will be understood that the unloading of airship 10 will of course be the reversed.

In accordance with the present invention, only a portion of the weight of the payload is carried by the lift caused by the rotors. In one embodiment of the present invention, 50% of the downward force (e.g. reverse lift) generated by the payload is carried by the lift generated by the rotors. The upward force of the positively buoyant airship prior to loading is also responsible for carrying a portion of the payload (e.g. 50%). As a result, a heavier payload can be carried by airships having conventional rotors. In other words, it is necessary to only have rotors capable of generating the upward vertical thrust or lift equal to the downward force of the negatively buoyant airship after loading. The generated thrust will be less than the weight or downward force of the payload. Therefore, heavier payloads can be carried with currently existing rotor technology. Alternatively, heavier payloads can be carried by smaller rotor systems, which can result in significant fuel costs savings.

It will be understood that any configuration of rotors and propellers necessary to achieve the upward, downward and forward forces or thrust as noted above would be encompassed by the present invention.

FIGS. 4 and 5 show an example of the present invention in operation with a load or payload 32 having a weight or downward force equal to 10 tons. It will be understood, however, that payloads of any size could be transported by an airship of appropriate size, lifted by embodiments of the present invention. If the airship is to transport a load of 10-tons, for example, the airship 10 flies into the loading area 5-tons “light” (e.g. having a generally positive buoyancy), controlling its altitude by regulating the downward thrust (i.e. reversed lift) from the rotors 12a and 12b, while propeller 14 provides for forward thrust (see FIG. 4). After airship 10 receives the 10 ton payload 32 and idles the power from the rotors, the airship is then lifting half the load (e.g. 5 tons) with its buoyancy (see FIG. 5), hence “leveraged lift”. The airship 10 is still, however, negatively buoyant by 5 tons. When powering up the rotors 12a and 12b for upwards thrust or lift, the airship 10 will lift the other 5-tons and is transporting a load of 10-tons, using engine/rotor power for only 5-tons. In other words, the airship of the present invention is lifting a 10 ton payload using only the force necessary to generate an upward force or lift equivalent to 5 tons.

Payloads can be under slung, hanging from a winch(es) or even be accommodated in a cargo compartment 34 inside the airship as is illustrated in FIG. 6.

In another embodiment, the airship 10 could have generally neutral buoyancy prior to loading the payload, rather than positive buoyancy as provided in the previous embodiment. The neutral buoyancy could arise from the presence of ballast, such as, for example, water ballast. The amount of ballast could be determined based on the characteristics of the payload as noted above. In other words, the amount of ballast will be equivalent to the amount by which the operator wished the airship to be positively buoyant in the absence of ballast or payload. As noted above, the degree to which the airship will be positively buoyant will eventually depend on the nature of the payload as noted above. In this embodiment, the airship has a neutral buoyancy as a result of ballast that is equivalent of up to at least 50% of the weight of the payload. As a result of the neutral buoyancy of the airship, there is no upward force or lift acting on the airship. Therefore, rotors 12a and 12b do not need apply a downward force or reverse lift upon the airship; this has been replaced by the downward force of the ballast acting on the airship. As a result of the downward force apply to the airships by the ballast, the airship will be generally neutrally buoyant.

After loading airship 10 with a payload, the ballast can be removed, thus creating a upward force equivalent to the weight (e.g. downward force) of the ballast removed. As a result, there still is a “leverage effect” due to the upward force once the ballast is removed. While water is the preferred ballast, it will be understood that other materials could be used as ballast, such as, sand, etc. However, the end result is that there will be an overall downward force due to the payload that will be compensated by the rotor lift as noted below.

In this embodiment, the operation after loading would be the same as in the previous example. In order to maintain a net neutral buoyancy of the airship 10, the rotors 12a and 12b can reverse pitch or change the direction of rotation so as to apply an upward force to the airship equal to that of the downward force of the now negatively buoyant airship (e.g. the airship with the payload and without the ballast). The load can be transported to the desired location. Upon unloading, the rotors simple reverse the thrust to compensate for the positively buoyant airship.

Various embodiments of the invention have now been described in detail. Since changes in and/or additions to the above-described best mode may be made without departing from the nature, spirit or scope of the invention, the invention is not to be limited to those details but only by the appended claims.

I claim:

1. A method of transporting a load from a loading site to a desired location with an airship comprising a reversible thrust apparatus, the method comprising:
(a) operating the airship at the loading site, the airship having a net generally neutral buoyancy, the net generally neutral buoyancy arising from a positive buoyancy of the airship and a reverse lift from the thrust apparatus equal to the positive buoyancy of the airship;
(b) loading the airship of step (a) with the load such that the airship has a negative buoyancy;
(c) applying lift to the airship of step (b) from the thrust apparatus so as to maintain the net generally neutral buoyancy of the airship;
(d) operating the loaded airship of step (c) to the desired location; and
(e) unloading the airship of step (c) at the desired location.

2. The method of claim 1 wherein the load has a reverse lift and the reverse lift of the load is greater than the positive buoyancy of the airship in step (a).

3. The method of claim 2 wherein the positive buoyancy of the airship in step (a) is equal to 50% of the reverse lift of the load.

4. The method of claim 3 wherein the negative buoyancy of the airship in step (b) is equal to 50% of the reverse lift of the load.

5. The method of claim 4 wherein the lift in step (c) is equal to 50% of the reverse lift of the load.

6. The method of claim 1 wherein the reversible thrust apparatus produces lift and reverse lift.

7. The method of claim 6 wherein the reversible thrust apparatus comprise at least one rotor.

8. The method of claim 7 wherein the rotor is mounted within a vertical duct, the vertical duct spanning the airship.

9. The method of claim 7 wherein the airship further comprises an outer envelop and the rotor is mounted on the outer envelope.

10. The method of claim 7 wherein the rotor is reversible pitch rotors.

11. The method of claim 7 wherein the rotor is reversible rotation rotors.

12. The method of claim 4 wherein step (e) further comprises applying reverse lift to the airship of step (e) so as to maintain the net generally neutral buoyancy of the airship.

13. The method of claim 1 wherein the airship is elongated, spherical or cylindrical.

14. The method of claim 13 wherein the airship can be rigid or non-rigid.

15. A method of transporting a load from a loading site to a desired location with an airship comprising a reversible thrust apparatus, the method comprising:
(a) operating the airship at the loading site, the airship having a net generally neutral buoyancy, the net generally neutral buoyancy arising from a positive buoyancy of the airship and a reverse lift generated by ballast;
(b) loading the airship of step (a) with the load and unloading the ballast such that the airship has a negative buoyancy;
(c) applying lift to the airship of step (b) from the thrust apparatus so as to maintain the net generally neutral buoyancy of the airship;
(d) operating the loaded airship of step (c) to the desired location; and
(e) unloading the airship of step (c) at the desired location.

16. The method of claim 15 wherein the load has a reverse lift and the reverse lift of the load is greater than the positive buoyancy of the airship in step (a).

17. The method of claim 16 wherein the positive buoyancy of the airship in step (a) is equal to 50% of the reverse lift of the load.

18. The method of claim 17 wherein the negative buoyancy of the airship in step (b) is equal to 50% of the reverse lift of the load.

19. The method of claim 18 wherein the lift in step (c) is equal to 50% of the reverse lift of the load.

20. The method of claim 15 wherein the reversible thrust apparatus produces lift and reverse lift.

21. The method of claim 20 wherein the reversible thrust apparatus comprise at least one rotor.

22. The method of claim 21 wherein the rotor is mounted within a vertical duct, the vertical duct spanning the airship.

23. The method of claim 21 wherein the airship further comprises an outer envelop and the rotor is mounted on the outer envelope.

24. The method of claim 15 wherein step (e) further comprises applying reverse lift to the airship of step (e) so as to maintain the net generally neutral buoyancy of the airship.
